(19) United States
(12) Patent Application Publication
(10) Pub. No.: US 2010/0178948 A1
(43) Pub. Date: Jul. 15, 2010

(54) APPARATUS AND METHOD FOR PROVIDING MAP INFORMATION USING SHORT MESSAGE SERVICE IN PORTABLE TERMINAL

(75) Inventors: Hyun-Su HONG, Seongnam-si (KR); Joo-Yoon BAE, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/686,868

(22) Filed: Jan. 13, 2010

(30) Foreign Application Priority Data
Jan. 13, 2009 (KR) 10-2009-0002522

(51) Int. Cl. H04W 4/12; G01C 21/36

(52) U.S. Cl. 455/466; 701/200; 701/208; 701/201

(57) ABSTRACT

An apparatus and method for providing map information using a short message service in a portable terminal are provided. An operation of the portable terminal includes extracting map data around a destination, generating a text message representing the map data, and sending the text message to a called party's portable terminal.

### PRIORITY

The present application claims priority under 35 U.S.C. §119(a) to a Korean Patent Application filed in the Korean Intellectual Property Office on Jan. 13, 2009 and assigned Serial No. 10-2009-0002522, the contents of which are herein incorporated by reference.

### BACKGROUND OF THE INVENTION

1. Field of the Invention

The present invention relates to a portable terminal, and more particularly, to an apparatus and method for providing map information using a Short Message Service (SMS) in a portable terminal.

2. Description of the Related Art

In general, a navigation equipment performs a guide role, in response to a user's request, by displaying a current position on a map, displaying a path between a current position and a destination, or displaying geographic information such as a user's moving path, etc. To accomplish this, the navigation equipment includes a display device for displaying the map and a Global Positioning System (GPS) module for detecting a user's current position. Namely, the GPS module determines an accurate coordinate of a user's current position using signals from GPS satellites, and the display device displays a user's current position on the map and displays a path to a destination selected by a user.

When a user intends to share the acquired position information with other users, a called party also has to possess a terminal supporting a map service, such as a navigation equipment. In other words, the user cannot share position information acquired through the GPS unless the called party's portable terminal has the capability to analyze map data. However, in some conditions, there is a need for the user to share position information although the called party is not equipped with the capability to analyze the map data. Thus, there is a need for an alternative for sharing position information with a terminal not equipped with the capability to analyze map data.

### SUMMARY OF THE INVENTION

An aspect of the present invention is to substantially solve at least the above problems and/or disadvantages and to provide at least the advantages below. Accordingly, one aspect of the present invention is to provide an apparatus and method for sharing position information with a terminal not equipped with the capability to analyze map data, in a portable terminal.

Another aspect of the present invention is to provide an apparatus and method for sharing map information using a Short Message Service (SMS) in a portable terminal.

A further aspect of the present invention is to provide an apparatus and method for configuring map information as a text message in a portable terminal.

The above aspects are achieved by providing an apparatus and method for providing map information using an SMS in a portable terminal.

According to one aspect of the present invention, a method for sharing map information in a portable terminal is provided. The method includes extracting map data around a destination, generating a text message representing the map data, and sending the text message to a called party's portable terminal.

According to another aspect of the present invention, a portable terminal apparatus is provided. The apparatus includes a controller for extracting map data around a destination and generating a text message representing the map data, and a communication unit for sending the text message to a called party's portable terminal.

### BRIEF DESCRIPTION OF THE DRAWINGS

The above and other objects, features and advantages of the present invention will become more apparent from the following detailed description when taken in conjunction with the accompanying drawings in which:

FIGS. 1A to 1C are diagrams illustrating an example of conversion of map information in a portable terminal according to an embodiment of the present invention;

FIG. 2 is a block diagram illustrating a construction of a portable terminal according to an embodiment of the present invention; and

FIG. 3 is a flow diagram illustrating a procedure of sharing map information in a portable terminal according to an embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

A technology for sharing map information using a Short Message Service (SMS) in a portable terminal according to an embodiment of the present invention is described below. That is, the present invention relates to a technology for transmitting map information to a portable terminal that does not include a navigation application, in a portable terminal that includes the navigation application. In the following description, the term “portable terminal” refers to all user equipments used in a mobile communication system such as a cellular phone, a Personal Communication System (PCS), a Personal Data Assistant (PDA), an International Mobile Telecommunication-2000 (IMT-2000) terminal, etc.

A portable terminal according to the present invention reconfigures an image of map information configured through a navigation application, as a text message. Information necessary for configuring the text message generally includes a destination, a peripheral main road or intersection, and nearby Point Of Interest (POI) information. This information can be acquired through a map information DataBase (DB). The portable terminal generates a text message using special characters that represent the listed information and sends the text message to a called party's portable terminal, thereby sharing the map information.

Preferably, the present invention includes a construction for converting position information of a map viewer and SMS-delivering a destination position using relative coordinate information between a main road and a destination, and the main road and a POI. In other words, the present invention obtains a relative coordinate of a final destination on the basis of a cross road closest to the destination or a specific POI designated by a user and expresses the destination and nearby POIs as a text message in accordance with the relative coordinate, thereby providing map information such as the nearby POI, a relative distance and direction to the destination, etc.

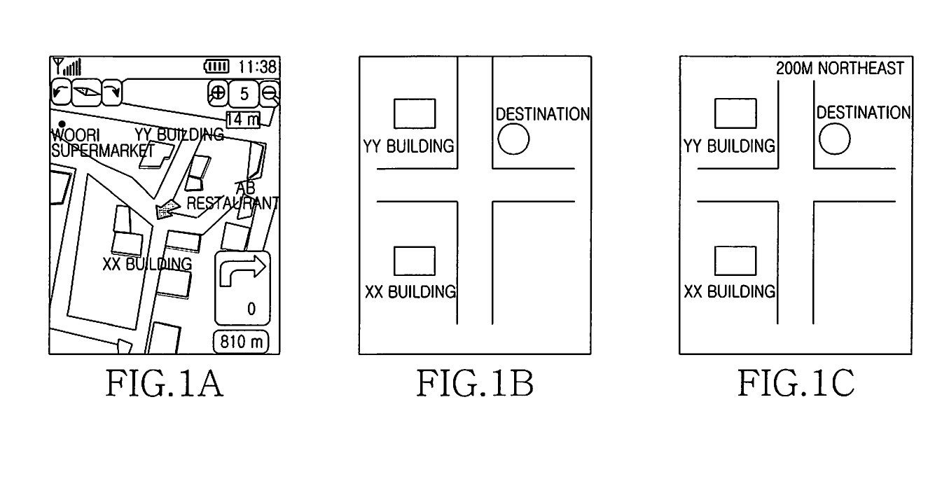

For example, according to the execution of a navigation application, the portable terminal displays a map screen as shown in FIG. 1A, and transmits the map information of FIG. 1A to other portable terminals that do not include a navigation application. Accordingly, as in FIG. 1B or 1C, the portable terminal converts the map information into a text message. FIG. 1B processes only a format of the map into a text message, and FIG. 1C states a direction and distance to a destination by words, thereby conveniently providing the recipient terminal with a means for finding a way to the destination.

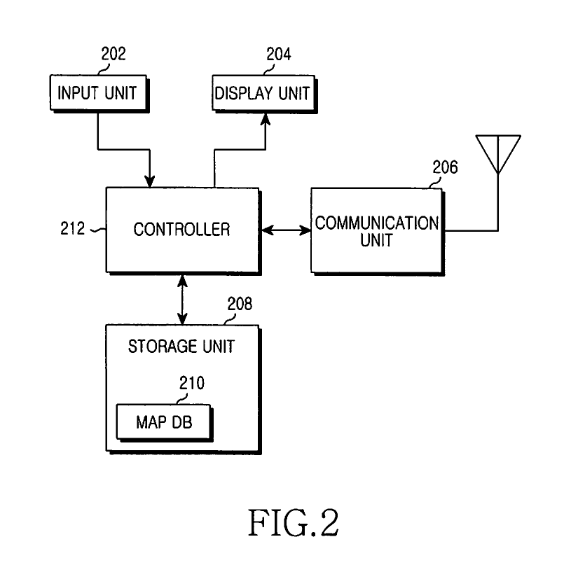

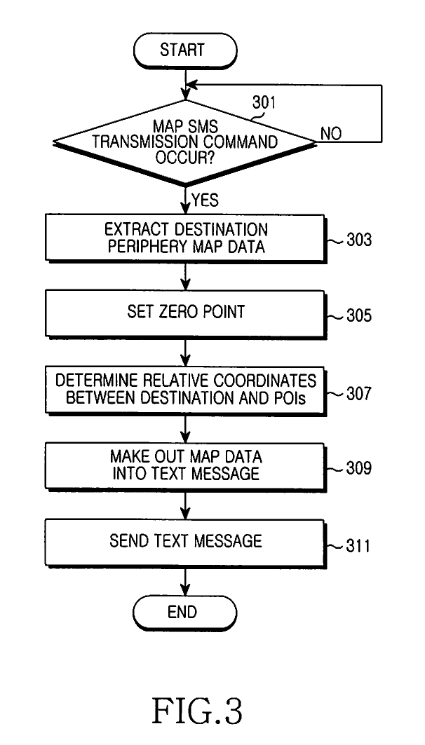

A construction and operation of a portable terminal for sharing map information as above are described below in detail with reference to FIGS. 2 and 3.

FIG. 2 is a block diagram illustrating a construction of a portable terminal according to an embodiment of the present invention.

As illustrated in FIG. 2, the portable terminal includes an input unit 202, a display unit 204, a communication unit 206, a storage unit 208, and a controller 212.

The input unit 202 recognizes an input generated by a user, and provides the controller 212 with information corresponding to the input. For example, the input unit 202 generates data corresponding to a user's input through a keypad, a touch screen, a touchpad, a special function button, etc. The display unit 204 displays state information generated during an operation of the portable terminal, as well as a numeral, a character, an image, etc. according to the execution of an application program. In other words, the display unit 204 outputs image data provided from the controller 212 such that a user can visually recognize the image data. For example, the display unit 204 can be a Liquid Crystal Display (LCD), an Organic Light-Emitting Diode (OLED), etc.

The communication unit 206 provides an interface for performing communication through a wireless channel. Namely, the communication unit 206 performs mutual conversion between information data and a transmission/reception signal in accordance with a standard of a system. Particularly, the communication unit 206 converts a text message including map information provided from the controller 212 into a physical Radio Frequency (RF) signal and transmits the RF signal through an antenna.

The storage unit 208 stores a microcode necessary for an operation of the portable terminal, an application, content, temporary data, etc. Particularly, the storage unit 208 stores a navigation application and a map data base (DB) 210 for the navigation application. The storage unit 208 also provides stored information in response to a request of the controller 212.

The controller 212 controls the general functions of the portable terminal. For instance, the controller 212 processes input data provided from the input unit 202 and provides image data to the display unit 204. Also, the controller 212 executes an application provided from the storage unit 208, and provides transmission data to the communication unit 206. Particularly, with respect to the present invention, the controller 212 controls a function for sharing map information through a text message. Namely, if a command for transmission of map information using an SMS (hereinafter, referred to as a “map SMS transmission command”) is generated by a user through the input unit 202 during the execution of a navigation application, the controller 212 generates map information comprised of an image into a text message, and sends the text message through the communication unit 206.

In detail, the controller 212 extracts a destination and destination periphery map data, and sets a zero point. The zero point refers to a center of a text message representing a map. The controller 212 sets the zero point according to the user's designation, or sets the zero point according to a predefined rule. For instance, a rule of setting as a zero point a cross road closest to the destination can be used. The controller 212 then determines relative coordinates between the destination and the POIs on the basis of the zero point, and then converts map data into a text message. For instance, the controller 212 sets a map on the basis of due North, positions the zero point at a center, displays a road using a special character such as ‘-’, ‘|’, ‘┌’, ‘┐’, ‘┘’, ‘└’, etc., and displays the destination and the POIs together with names in positions of corresponding relative coordinates using a special character such as ‘⋆’, ‘□’, etc._In addition, the controller 212 can insert guide words indicating a distance and direction to the destination.

FIG. 3 is a flow diagram illustrating a procedure of sharing map information in a portable terminal according to an embodiment of the present invention.

Referring to FIG. 3, in step 301, the portable terminal identifies if a map SMS transmission command occurs by a user. Namely, during the execution of a navigation application, the portable terminal identifies if a key input or menu selection corresponding to the map SMS transmission command is generated.

If the map SMS transmission command is generated, the portable terminal proceeds to step 303 and extracts destination and destination periphery map data. That is, the portable terminal extracts position information on the destination, name and position information on POIs around the destination, and information on a road or roads around the destination.

Next, the portable terminal proceeds to step 305 and sets a zero point. The zero point refers to a center of a text message representing a map. The portable terminal sets the zero point according to the user's designation, or sets the zero point according to a predefined rule. For instance, a rule of setting as a zero point a cross road closest to the destination can be used.

After setting the zero point, the portable terminal proceeds to step 307 and determines relative coordinates between the destination and the POIs on the basis of the zero point. In other words, the portable terminal determines the relative coordinates between the destination and the POIs with respect to a direction and distance based on the zero point.

After determining the relative coordinates, the portable terminal proceeds to step 309 and converts the map data into a text message. For instance, the portable terminal sets a map on the basis of due North, and positions the zero point at a center. The portable terminal then displays a road using a special character such as ‘-’, ‘|’, ‘┌’, ‘┐’, ‘┘’, ‘└’, etc., and displays the destination and the POIs together with names in positions of corresponding relative coordinates using a special character such as ‘⋆’, ‘□’, etc._In addition, the portable terminal can insert guide words of indicating a distance and direction to the destination.

After generating the text message, the portable terminal proceeds to step 311 and sends the text message. Namely, the portable terminal sends the text message representing the map to a portable terminal corresponding to a phone number input by a user. By this, the user of the portable terminal can share map information with a user of a portable terminal that does not include a navigation application.

The present invention can share map information with a portable terminal that does not include a navigation application, by converting map information expressed as an image into a text message in a portable terminal applying the navigation application.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for sharing map information in a portable terminal, the method comprising:
extracting map data around a destination;
generating a text message representing the map data; and
sending the text message to a called party's portable terminal.

2. The method of claim 1, wherein generating the text message comprises:
setting a zero point;
determining a relative coordinate between the destination and at least one Point Of Interest (POI) on the basis of the zero point; and
converting a road, the destination, and the at least one POI into a text message using a special character.

3. The method of claim 2, wherein the zero point is set according to a user's designation.

4. The method of claim 2, wherein the zero point is set as a cross road closest to the destination.

5. The method of claim 2, wherein generating the text message comprises inserting guide words indicating a distance and direction to the destination, into the text message.

6. A portable terminal apparatus comprising:
a controller for extracting map data around a destination, and generating a text message representing the map data; and
a communication unit for sending the text message to a called party's portable terminal.

7. The apparatus of claim 6, wherein the controller sets a zero point, determines a relative coordinate between the destination and at least one Point Of Interest (POI) on the basis of the zero point, and converts a road, the destination, and the at least one POI into a text message using a special character.

8. The apparatus of claim 7, wherein the zero point is set according to a user's designation.

9. The apparatus of claim 7, wherein the zero point is set as a cross road closest to the destination.

10. The apparatus of claim 7, wherein the controller inserts guide words indicating a distance and direction to the destination, into the text message.
